(19) United States
(12) Patent Application Publication
(10) Pub. No.: US 2008/0001921 A1
(43) Pub. Date: Jan. 3, 2008

(54) Inverted mouse apparatus

(75) Inventor: Tzu-Hung Chen, Hsinchu (TW)

Correspondence Address: BIRCH STEWART KOLASCH & BIRCH, PO BOX 747, FALLS CHURCH, VA, 22040-0747, US

(73) Assignee: Airwave Technologies Inc.

(21) Appl. No.: 11/476,072

(22) Filed: Jun. 28, 2006

(51) Int. Cl. G09G 5/08

(52) U.S. Cl. 345/166

(57) ABSTRACT

An inverted mouse apparatus having a movable plate, a main surface structure and a displacement-detecting device is disclosed herein. The attaching element set on the movable plate can be utilized to attach it on a finger that can operate and control the movable plate in three dimensions. The main surface structure is disposed under the movable plate, and both the movable plate and the main surface structure have the adsorptive elements to attach to each other. The displacement-detecting device is set right under the main surface structure to detect the horizontal displacement and direction of the movable plate relative to the main surface structure. Thus an inverted mouse apparatus without the need of the sliding-on-desk or sliding-on-pad operation is provided. The mouse apparatus can not only mimic the movable-type mouse which most people are used to but also control the movement of the cursor more precisely than the stationary-type mouse.

### BACKGROUND

1. Field of the Invention

The present invention generally relates to a mouse apparatus, and more specifically, to a mouse having the inverted apparatus so that it can mimic the operation of a traditional mouse but without the need of sliding on desk or sliding on pad.

2. Description of the Prior Art

With the coming of the information age, the computer has become the necessary tool of the daily life for almost every ordinarily person. The mouse is one of the essential peripherals of the computer to provide a convenient operation interface for human. There are numerous kinds of the mouse, however, it can be roughly classified into two types according to that the mouse body needs to be moved or keep still during the operation. The movable-type mouse must to be used on the desk or the pad, so they are mostly equipped with the desktop computer; the stationary-type mouse with the advantage of requiring less space of operation is usually equipped with the notebook computer. The conventional stationary-type mouse can be further classified into three types: the track ball or the track stick, the touch pad and the touch panel, according to the differences in working principles and physical structures. However, the fact that the precise moving speed and position of the cursor could not be controlled easily is the common drawback of these types of stationary-type mouse such that most notebook computer users still have to use an additional detachable movable-type mouse to make the operation of the cursor much more easier.

The Taiwan patent number 584,285 describes an optical mouse, which includes a base with a compartment. The control of the cursor movement by the optical mouse can be achieved by the back-and-forth and/or right-and-left displacements of a sensing board mounted inside the compartment and on top of the bottom surface. The displacements of the board are transferred into the changes of the light signals reflected from the bottom surface at different locations with different identification marks. However, when the mouse is placed on a tilted surface or the base is shaken by a careless touch, the sensing board may slide off from its position that it should be and so as to induce the drifting and waving problem of the cursor. Moreover, this method lacks the mechanism to freely turn on/off the control function of the sensing board for the cursor movement. When the sensing board is moved to anyone of the edges of the compartment, it can't be move back to the opposite edge without changing the position of the cursor in order to move the cursor in the same direction continuously. This results in that the maximum effective moving-distance is limited to the physical-size of the compartment of the sensing board, and so that the accuracy of controlling the position of the cursor will also be limited. Due to these shortcomings abovementioned, the practicability of the mentioned patent is quite limited. Hence, the main purpose of the present invention is to provide an apparatus to overcome the common drawback of the two kinds of the conventional mouse and the quoted patent. In addition, its application won't be limited to the optical mouse, but also is realizable for the low-cost rolling-ball type mouse to additionally resolve its problem of being easily polluted on the surface of the rolling ball.

### SUMMARY OF THE INVENTION

The main feature of the present invention is to provide an inverted mouse apparatus, which can be utilized to control the cursor movement without the need of the sliding on desk or sliding on pad.

Another feature of the present invention is to provide a mouse apparatus which can be used to control the speed and position of the cursor more precisely than the conventional stationary-type mouse.

Another feature of the present invention is to provide a stationary-type mouse apparatus that can mimic the operation of a movable-type mouse which most people are used to.

Another feature of the present invention is to provide a mouse apparatus with the power saving mechanism.

Accordingly, an inverted mouse apparatus according to an embodiment of the present invention includes a movable plate, a main surface structure and a displacement-detecting device. An attaching element set on the surface of the movable plate is utilized to attach the movable plate on a finger that can operate and control the movement of the movable plate in three dimensional space, and a first adsorptive element is set within the movable plate. The main surface structure is set under the movable plate and on the top of a housing. A second sliding surface surrounded by a restricting flange in the four edges is set on the main surface structure to confine the moving area of the movable plate. The main surface structure has a second adsorptive element which can be utilized along with the first adsorptive element of the movable plate to attach the movable plate to the top of the main surface structure, so that the user can start or stop operating the movable plate at any time to control the movement of the cursor. And, it can also prevent the cursor drifting and waving problem from being placed on a tilted surface or careless touch of the mouse apparatus when the movable plate is kept stationary. The displacement-detecting device set under the main surface structure is utilized to detect the horizontal displacement and direction of the movable plate relative to the main surface structure.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic side view of the structure of the inverted optical-mouse apparatus of the first type in accordance with the present invention;

FIG. 2 is a schematic side view of the structure of the third-type circuit switch in accordance with the present invention;

FIG. 3 is a top view of the structure of the optical-mouse apparatus of an embodiment in accordance with the present invention;

FIG. 4 is a side view of the structure of the circuit switch of the first type in accordance with the present invention;

FIG. 5 is a top perspective view of the structure of the circuit switch of the first type in accordance with the present invention;

FIG. 6 is a side view of the structure of the circuit switch of the second type in accordance with the present invention;

FIG. 7 is a side view of the structure of the main surface structure of the inverted rolling-ball mouse apparatus in accordance with the present invention;

FIG. 8 is a top perspective view of the structure of the main surface structure of the inverted rolling-ball mouse apparatus in accordance with the present invention;

FIG. 9 is a side view of the structure of the main surface structure of the inverted rolling-ball mouse apparatus during the operation in accordance with the present invention;

FIG. 10 is a schematic view of the structure of the main surface structure including a plurality of keys in accordance with the present invention;

FIG. 11 is a side view of the structure of the second type of the inverted optical-mouse apparatus with the third type of the circuit switch, in accordance with the present invention;

FIG. 12 is a side view of the structure of the second type of the inverted optical-mouse apparatus with the first type of the circuit switch, in accordance with the present invention;

FIG. 13 is a side view of the structure of the second type of the inverted optical-mouse apparatus with the second type of the circuit switch in accordance with the present invention; and

FIG. 14 is a side view of the structure of the second type of the inverted rolling-ball mouse apparatus of the second type in accordance with the present invention.

### DESCRIPTION OF THE PREFERRED EMBODIMENT

The present invention is to provide an inverted mouse apparatus, the users can precisely control the position of the cursor by way of moving the movable plate which is attached on the finger on the top of the main surface structure. The present invention can be applied to the displacement detector of the optical mouse apparatus and the rolling-ball type mouse apparatus.

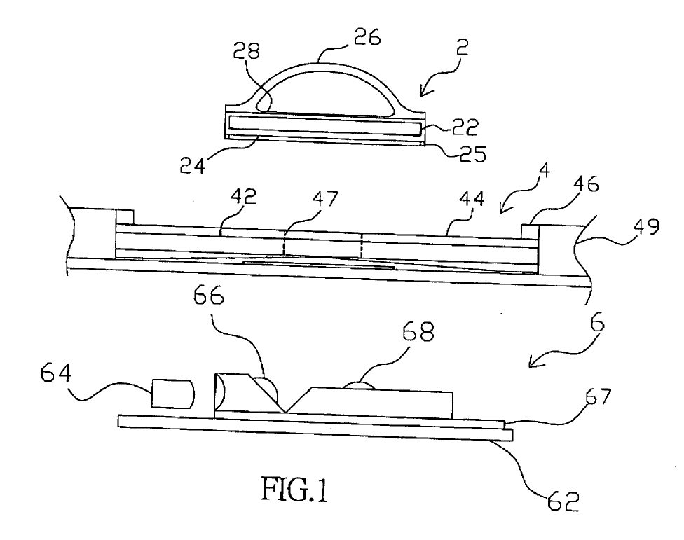

Such as shown in FIG. 1, an embodiment of the present invention, is a schematic side view of the structure of the inverted optical-mouse apparatus of the first type, in accordance with the present invention. The present invention includes a movable plate 2, a main surface structure 4, and an optical displacement detector 6. Wherein, the movable plate 2 has a first adsorptive element 22 on the top surface and a first sliding surface 24 on the bottom surface with an elastic flange 25 surrounding in its four edges. Wherein the elastic flange 25 is utilized to keep a gap between the movable plate 2 without being pressed down and the second sliding surface 44 of the main surface structure 4, so as to have the space to hold the portion of the main surface structure 4 which is above the second sliding surface 44 under the movable plate 2 and to keep the optical displacement detector 6 in the stand-by mode. In regard to the operation of the movable plate 2 without the elastic flange 25, the movable plate 2 need to be lifted up to make the optical-displacement detector 6 enter into the stand-by mode. A concave 28 with the shape matching the finger and the skidproof material are disposed on the upper surface of the movable plate 2; an attaching element 26 is set on the surface of the movable plate 2 in addition, wherein the attaching element 26 is a strap loop or a third adsorptive element which has a long lasting sticky surface or a sucking disk so that the movable plate 2 can be attached on the finger and can be controlled to move in three dimensions; the main surface structure 4 is set under the movable plate 2 and set on the top of the housing 49. Wherein the main surface structure 4 has a second adsorptive element 42 and its upper surface is a second sliding surface 44; the optical-displacement detector 6 set right under the main surface structure 4 is utilized to detect the horizontal displacement and direction of the movable plate 2 relative to the main surface structure 4. A restricting flange 46 which surrounds the main surface structure 4 is utilized to limit the moving area of the movable plate 2, and a see-through opening 47 is set on the central position of the main surface structure 4.

Wherein the first adsorptive element 22 is the magnetic layer; the second adsorptive element 42 is the permeance layer, and both of them can attract with each other and are interchangeable so that the movable plate 2 can be attracted and attached on the main surface structure 4. In another embodiment, the first adsorptive element 22 also can be a sucking disk with controllable inflating and flatting function, and the second adsorptive element 42 is then a transparent and airproof smooth layer on the top of the second sliding surface 44. When the movable plate 2 is pressed down against the main surface structure 4, the sucking disk turns on the inflating and flatting function, so as the adsorptive force is released and the movable plate 2 can be moved around freely. On the other hand, when the pressure on the movable plate 2 is removed, the inflating and flatting function of the sucking disk is turned off, and so that the movable plate 2 can be held still on the main surface structure 4 by the adsorptive force generated from the resilience of the sucking disk.

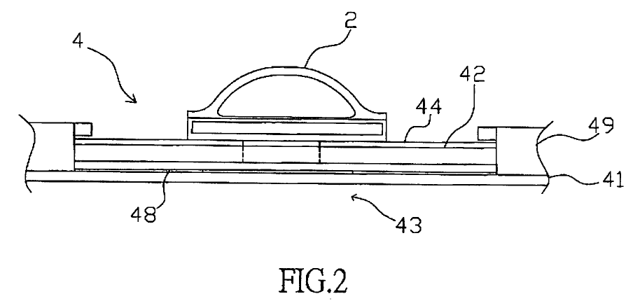

FIG. 2 is a schematic side view of the structure of the strap loop-type movable plate and the third-type circuit switch, in accordance with the present invention. The second sliding surface 44 and the second adsorptive element 42 of the main surface structure 4 are constructed as a vertically movable plate inside the housing 49, and a third spring device 48 and a third circuit board 41 disposed thereunder are utilized to support it. An elastical force circuit switch 43 is made of the third spring device 48 and the third circuit board 41. When the vertical movable plate of the main surface structure 4 follows the vertical-movement of the movable plate 2, the third spring device 48 will be pressed or released accordingly and result in the on-state/off-state of the elastical force circuit switch 43. FIG. 2 shows the on-state condition; FIG. 1 shows the off-state condition.

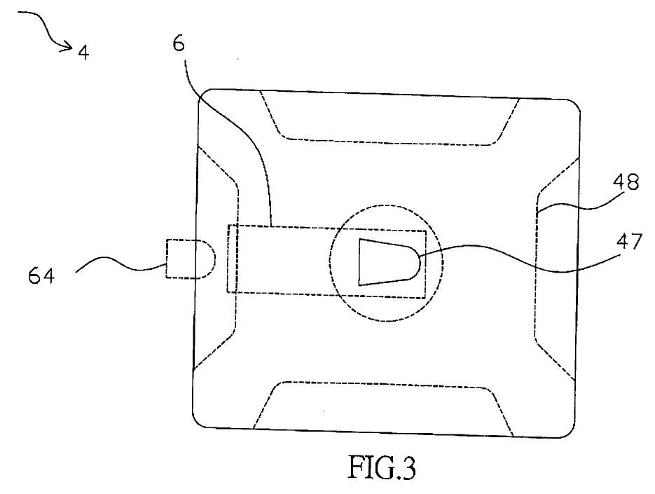

FIG. 3 is a top view of the structure of the inverted optical-mouse apparatus of an embodiment, in accordance with the present invention. Please refer to FIG. 3 and FIG. 1 at the same time, the optical-displacement detector 6 is set on the first circuit board 62, and the optical-displacement detector 6 is made of a light emitter 64, a light-guide and lens module 66, a light sensor 68, and an identification/encoder/controller circuit 67. When entering the cursor operation mode of the mouse, the light emitted from the light emitter 64 passes through the light-guide and lens module 66 and the see-through opening 47 of the main surface structure 4 and then is irradiated on the first sliding surface 24 of the movable plate 2 via that the light is reflected to and received by the light sensor 68. As the first sliding surface 24 of the movable plate 2 slides closely on the second sliding surface 44 of the main surface structure 4, the intensity of the light reflected from the movable plate 2 and received by the light sensor 68 changes according to the different characteristics of the surface of the movable plate 2. The change of the position of the movable plate 2 can be obtained by identifying the change of the light, and so as to achieve the goal of controlling the cursor position of the mouse. The detail of the operational principle and techniques for the optical displacement detector is well known, so it won't be further described here. When the movable plate 2 with an elastic flange 25 doesn't be pressed down or is lifted up, there is a gap formed between the movable plate 2 and the main surface structure 4. The gap can make the optical-displacement detector 6 inactive and stay in the stand-by mode. At the same time, the circuit switch 43 is also turned off by the third spring device 48, and so as to terminate the cursor-controlling operation and also enter into the power-saving mode. By utilizing this mechanism, the cursor-controlling operation can be continuously repeated within the same area of the second sliding surface 44 of the main surface structure 4. As the movable plate 2 is stationary, it can be firmly kept in the same position by the attractive force between the first adsorptive element 22 and the second adsorptive element 42. In this way, the drifting and waving problem of the cursor caused by the tilted placement or careless touch of the mouse apparatus can be avoided.

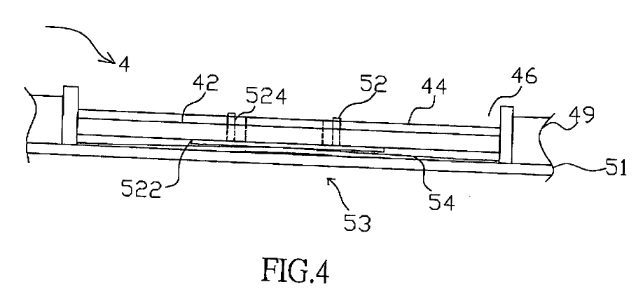

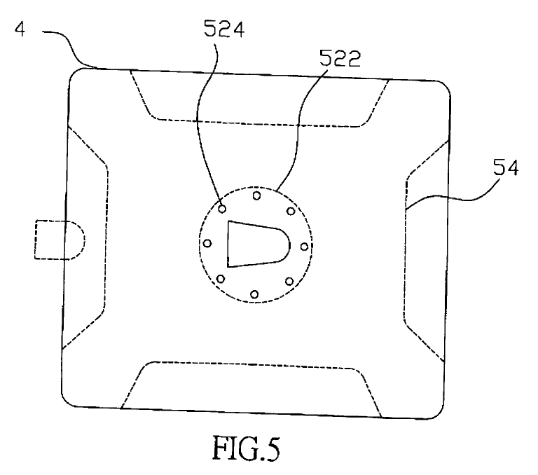

Referring to FIG. 4 and FIG. 5, which are the side view and top view of the structure of the circuit switch of the first type, in accordance with the present invention. The second sliding surface 44 of the main surface structure 4 and the second adsorptive element 42 are fixed within the housing 49 and pierced through a first spring linkage structure 52, and a first spring device 54 and a second circuit board 51 are set thereunder. The first spring linkage structure 52 is a thin plate 522 with a plurality of short pillars 524 disposed thereon. The short pillars 524 penetrate through and expose over the second sliding surface 44 of the main surface structure 4. And an elastical force circuit switch 53 is made up of the first spring device 54 and the second circuit board 51 set thereunder. When the short pillars 524 are pressed down by the movable plate 2, the first spring linkage structure 52 can force the first spring device 54 to be pressed and switch on the circuit switch 53.

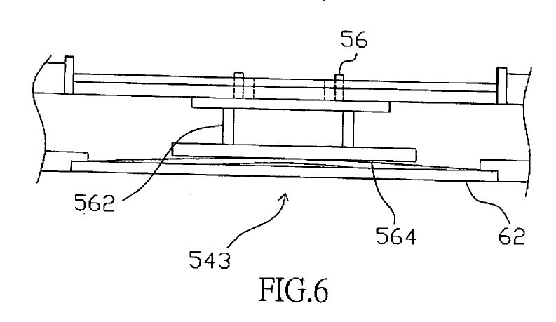

FIG. 6 is a side view of the structure of the circuit switch of the second type in accordance with the present invention. The difference between the first type and the second type circuit switch is that the first spring linkage structure 52 of the first type circuit switch has been replaced by the second spring linkage structure 56 which is supported by a plurality of elastical sustaining pins 562 thereunder, and the first spring device 54 of the first type circuit switch has also been replaced by the second spring device 564 which is set underneath the elastical sustaining pins 562 and on the first circuit board 62. Then an elastic force circuit switch 543 are forced jointly the second spring linkage structure 56, the elastical sustaining pins 562, and the second spring device 564. Similar to the function of the first type circuit switch, when the second spring linkage structure 56 is pressed down by the movable plate 2, the second spring device 564 can be pressed accordingly and switch on the circuit switch 543. The above-mentioned elastic force circuit switch 543 also can be replaced by a push-on switch, which is set on the first circuit board 62 and controlled by the second spring device 564.

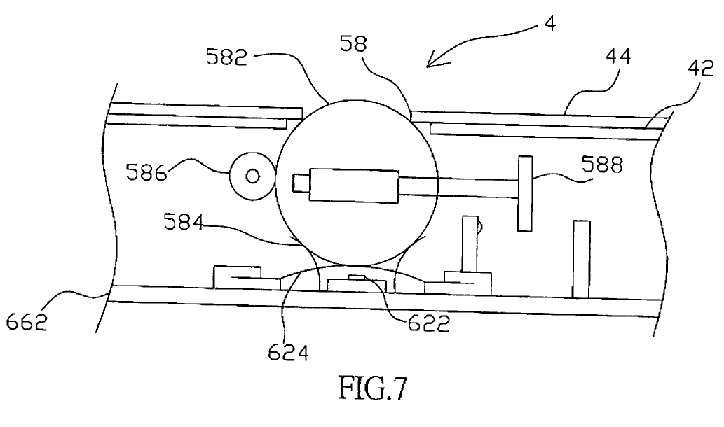

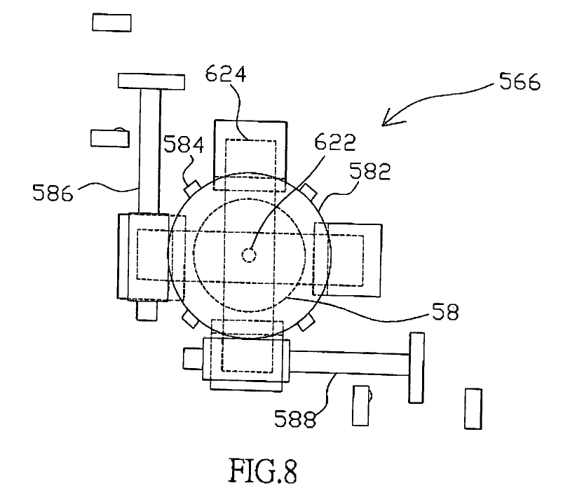

Another embodiment of the present invention is about an inverted rolling-ball mouse apparatus. As shown in FIG. 7 and FIG. 8, which are the side view and the top perspective view of the structure of the main surface structure of the inverted rolling-ball mouse apparatus, in accordance with the present invention. A round aperture 58 is set in the central position of the main surface structure 4, and a rolling ball 582 made of a light-weight material in order to reduce the overall weight is set within the main surface structure 4. An elastically-supporting and positioning structure 584 consisted of a plurality of supporting spring devices are utilized to support the rolling ball 584, so that a small part of the rolling ball 582 is exposed over the round aperture 58 of the main surface structure 4. The rolling-ball displacement-measuring devices set in two sides of the rolling ball 582 perpendicularly include an X-axis displacement-measuring wheel module 586, a Y-axis displacement-measuring wheel module 588, and their corresponding displacement readers. All of the above-mentioned devices, including the rolling ball 582, the elastically-supporting and positioning structure 584, X-axis and Y-axis displacement-measuring wheel module 586, 588 and the their corresponding displacement readers are combined into a rolling-ball displacement detector 566. Additionally, the rolling-ball displacement detector 566 and an identification/encoder/controller circuit 67 are set on a fourth circuit board 662. When the movable plate 2 doesn't be pressed down, the elastic flange 25 is utilized to form a gap between the first sliding surface 24 and the rolling ball 582 so that the movable plate 2 can move freely and the rolling ball 582 keeps still; as to the operation of the movable plate 2 without the elastic flange 25, the movable plate 2 is lifted up to form a gap so as to keep the rolling ball 582 still. However, when the movable plate 2 is pressed down so that the first sliding surface 24 closely slides on the second sliding surface 44 of the main surface structure 4, the rolling ball 582 can be forced down and driven to rotate accordingly by the first sliding surface 24. The rolling ball 582 being pressed down just touches the wheels of the X-axis and Y-axis displacement-measuring wheel module 586, 588 with its horizontal ring-shaped surface where the ring has the largest periphery and hence brings along them into rotation. The rotation lengths of the two wheels can be transformed into displacements by the displacement readers and processed by the identification/encoder/controller circuit 67, by this way, it can be achieved to control the operation of the cursor position. Because the detail of the operational principle and techniques for the rolling-ball displacement detector is well-known, it won't be further described here.

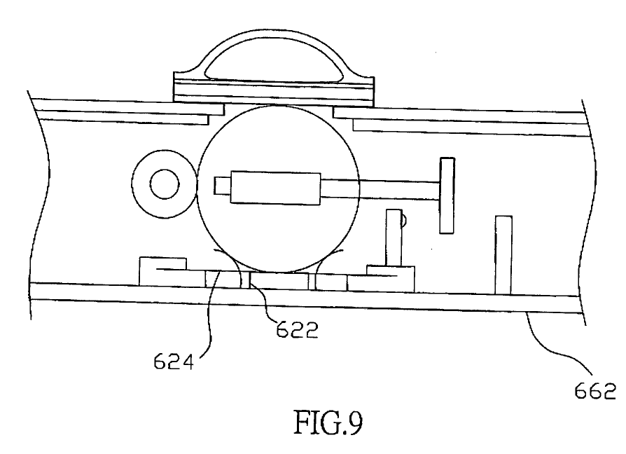

A circuit switch 622, which is set above the fourth circuit board 662 of the rolling-ball displacement detector 566 and set right below the horizontally-mounted spring device 624 of the elastically-supporting and positioning structure 584 is a push-on circuit switch. When the horizontally-mounted spring device 624 of the elastically-supporting and positioning structure 584 is forced down by the rolling ball 582, the circuit switch 622 is pressed and activated to start the cursor-positioning function and the power-saving function. FIG. 9 shows the condition when the circuit switch 622 is pressed, wherein the push-on switch of the circuit switch 622 can be replaced by the horizontally-mounted spring device 624 and the fourth circuit board 662 having a plurality of properly designed contact points set thereon.

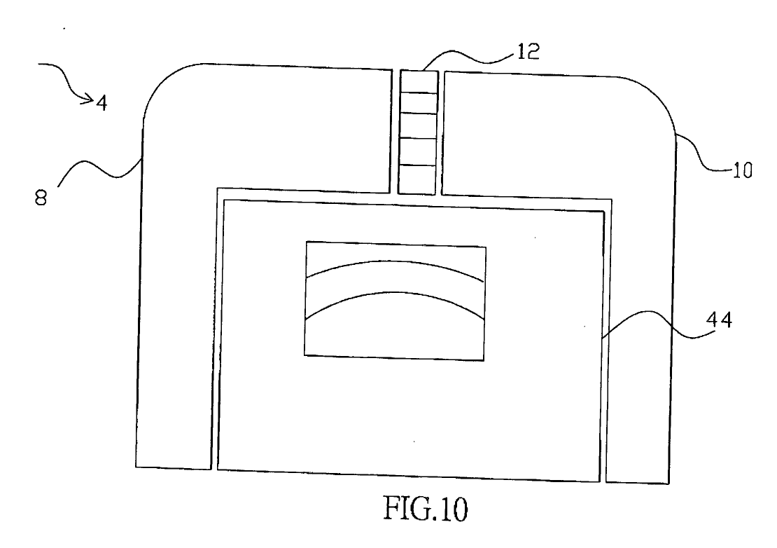

Please refer to FIG. 10, FIG. 1 and FIG. 7 at the same time. The housing 49 of the main surface structure 4 of the inverted optical and rolling-ball mouse apparatus further includes a plurality of keys to assist with the operation of the mouse apparatus. The keys include a left-key 8, a right-key 10 and a wheel-key 12, wherein the left-key 8 and the right-key 10 are symmetrically set on the left-top side and the right-top side of the second sliding surface 44 of the main surface structure 4. The wheel-key 12 is set on the top side of the second sliding surface 44 of the main surface structure 4 and between the left-key 8 and the right-key 10, so that the inverted mouse apparatus can be conveniently utilized for left-hand operation or right-hand operation.

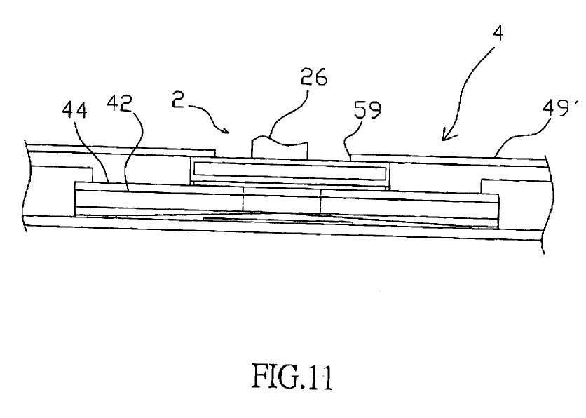

FIG. 11 is a side view of the structure of the second type of the inverted optical-mouse apparatus with the third type of the circuit switch in accordance with the present invention. The differences between the second type and the first type (shown in FIG. 2) are described in the following. The second sliding surface 44 of the main surface structure 4 and the second adsorptive element 42 are set on a vertical-moving plate within the housing 49′, and the movable plate 2 is set between the housing 49′ and the second sliding surface 44 of the main surface structure 4. Besides, the aperture 59 of the housing 49′ is smaller than the movable plate 2, and the attaching element 26 of the movable plate 2 is exposed over the aperture 59 of the housing 49′. The attaching element 26 is utilized to move the movable plate 2 in horizontal direction and to lift up and push down the movable plate 2 vertically. The rest of the structure is the identical for both types.

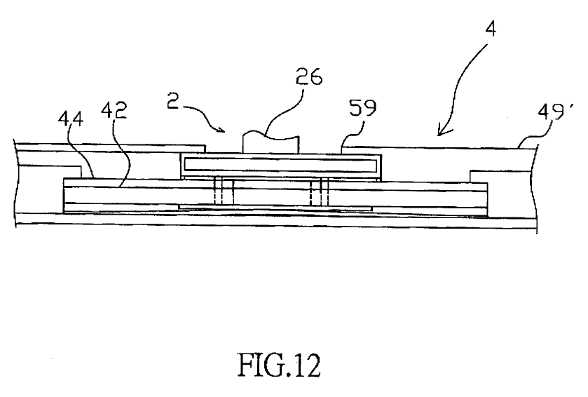

FIG. 12 is a side view of the structure of the second type of the inverted optical-mouse apparatus with the first type of the circuit switch in accordance with the present invention. The differences between the second type and the first type (shown in FIG. 4) are described in the following. The second sliding surface 44 of the main surface structure 4 and the second adsorptive element 42 are set fixedly within the housing 49′, and the movable plate 2 is set between the housing 49′ and the second sliding surface 44 of the main surface structure 4. The aperture 59 of the housing 49′ is smaller than the movable plate 2, and the attaching element 26 is exposed over the aperture 59 of the housing 49′. Additionally, the attaching element 26 is utilized to make the movable plate 2 move vertically and horizontally. The rest of the structure is identical for both types.

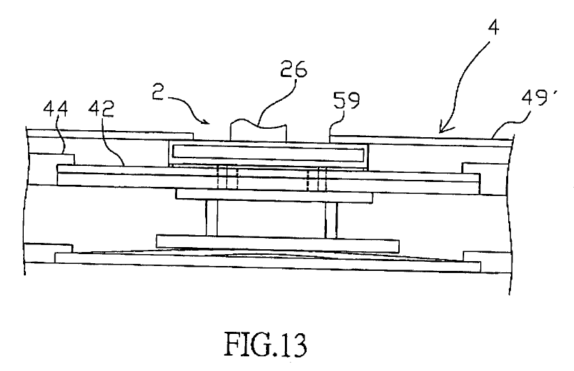

FIG. 13 is a side view of the structure of the second type of the inverted optical-mouse apparatus with the second type of the circuit switch in accordance with the present invention. The differences compared to the first type (shown in FIG. 6) are described in the following. The second sliding surface 44 of the main surface structure 4 and the second adsorptive element 42 are set fixedly within the housing 49′, and the movable plate 2 is located between the housing 49′ and the second sliding surface 44 of the main surface structure 4. The aperture 59 of the housing 49′ is smaller than the movable plate 2, and the attaching element 26 is exposed over the aperture 59 of the housing 49′. Additionally, the attaching element 26 is utilized to move the movable plate 2 in horizontal direction and to lift up and push down the movable plate 2 vertically. The rest of the structure is identical for both types.

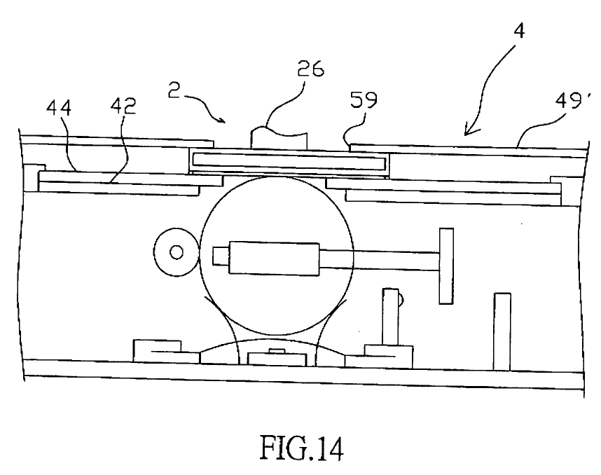

FIG. 14 is a side view of the structure of the second type of the inverted rolling-ball mouse apparatus in accordance with the present invention. The differences compared to the first type (shown in FIG. 7) are described in the following. The second sliding surface 44 of the main surface structure 4 and the second adsorptive element 42 are set fixedly within the housing 49′, and the movable plate 2 is located between the housing 49′ and the second sliding surface 44 of the main surface structure 4. The aperture 59 of the housing 49′ is smaller than the movable plate 2, and the attaching element 26 is exposed over the aperture 59 of the housing 49′. Additionally, the attaching element 26 is utilized to move the movable plate 2 in horizontal direction and to lift up and push down the movable plate 2 vertically. The rest of the structure is identical for both types.

Accordingly, the present invention herein is to provide an inverted mouse apparatus, which can be utilized to control the cursor movement without the need of sliding on desk or sliding on pad. An attaching element set on the movable plate can be utilized to attach it on the finger that can operate and control the movable plate to slide on the working area of the main surface structure. This design can mimic the operation of the conventional movable-type mouse, so the user can control the position of the cursor more precisely. Besides, the adsorptive elements of the movable plate and the main surface structure can prevent the drifting and waving problem of the cursor caused by the tilted placement or careless touch of the mouse apparatus when the movable plate should be kept still. The structure of the present invention herein can let the user freely start or stop the cursor-controlling function of the mouse at any time, so that the movable plate can be used the limited working area of the main surface structure to continuously repeat the control of the cursor movement. In this way, the control accuracy of the cursor position can be greatly increased.

Although the present invention has been explained in relation to its preferred embodiment, it is to be understood that other modifications and variation can be made without departing the spirit and scope of the invention as hereafter claimed.

What is claimed is:

1. An inverted mouse apparatus comprising:
a movable plate having a first adsorptive element and a first sliding surface set on the bottom surface thereof, wherein an attaching element set on the surface of said movable plate is utilized to attach said movable plate on a finger that can operate and control said movable plate to move in three dimensions, and said movable plate can be lifted up to make the cursor-controlling function enter into a stand-by mode;
a main surface structure set under said movable plate and set on the top of a housing, wherein said main surface structure has a second adsorptive element and the upper surface thereof is a second sliding surface, and said movable plate can be moved around or attached on said second sliding surface by the means of said first adsorptive element and said second adsorptive element; and
a displacement-detecting device set right under said main surface structure is utilized to detect the horizontal displacement and direction of said movable plate relative to said main surface structure.

2. The inverted mouse apparatus according to claim 1, wherein a restricting flange is set on the surrounding of said main surface structure to limit the moving area of said movable plate.

3. The inverted mouse apparatus according to claim 1, wherein said first adsorptive element is a magnetic layer and said second adsorptive element is a permeance layer, the two adsorptive elements can attract with each other and are interchangeable so that said movable plate can be attracted and attached on said main surface structure.

4. The inverted mouse apparatus according to claim 1, wherein said first adsorptive element is a sucking disk with controllable inflating and flatting function, and said second adsorptive element is a transparent and airproof smooth layer on the top of said second sliding surface; when said movable plate is pressed down against said main surface structure, said sucking disk turns on the inflating and flatting function, so as the adsorptive force is released and said movable plate can be moved around freely; when the pressure on said movable plate is removed, the inflating and flatting function of said sucking disk is turned off and so that said movable plate can be held still on said main surface structure by the adsorptive force generated from the resilience of the sucking disk.

5. The inverted mouse apparatus according to claim 1, wherein a circuit switch controlled by said movable plate is set within said main surface structure to start or stop the cursor-controlling function and the power-saving function.

6. The inverted mouse apparatus according to claim 1, wherein said first sliding surface of said movable plate comprising an elastic flange surrounding thereof so that said first sliding surface and said second sliding surface of said main surface structure keep a gap between them to hold the portion of said main surface structure which is above said second sliding surface to keep said circuit switch in off state and make said displacement-detecting device stay in the stand-by mode.

7. The inverted mouse apparatus according to claim 1, wherein said attaching element of said movable plate is a strap loop utilized to circle the finger so that said movable plate can be controlled to move in three dimensions.

8. The inverted mouse apparatus according to claim 1, wherein a concave with the shape matching the finger outline and the skidproof material are disposed on the surface of said movable plate.

9. The inverted mouse apparatus according to claim 1, wherein said attaching element is a third adsorptive element set on the surface of said movable plate so that said movable plate can be attached on the finger to move in vertical and horizontal direction.

10. The inverted mouse apparatus according to claim 9, wherein said third adsorptive element has a long lasting sticky surface or a sucking disk.

11. The inverted mouse apparatus according to claim 1, wherein a see-through opening is set on the central position of said second sliding surface of said main surface structure.

12. The inverted mouse apparatus according to claim 11, wherein said displacement-detecting device is an optical displacement detector set on a first circuit board.

13. The inverted mouse apparatus according to claim 11, wherein said second sliding surface of said main surface structure and said second adsorptive element are fixed within said housing and pierced through a first spring linkage structure, and a first spring device and a second circuit board are set thereunder; said first spring linkage structure is a thin plate with a plurality of short pillars disposed thereon so that said first spring linkage structure and said first spring device are utilized to control said circuit switch.

14. The inverted mouse apparatus according to claim 13, wherein said circuit switch is made of said first spring device and said second circuit board disposed thereunder.

15. The inverted mouse apparatus according to claim 11, wherein said second sliding surface of said main surface structure and said second adsorptive element are fixed within said housing and pierced through a second spring linkage structure, and a second spring device are set on a first circuit board thereunder; said second spring linkage structure is a thin plate with a plurality of short pillars disposed thereon, and a plurality of elastical sustaining pins are set under said thin plate so that said second spring linkage structure and said second spring device is utilized to control said circuit switch.

16. The inverted mouse apparatus according to claim 15, wherein said circuit switch is made of said second spring device and said first circuit board.

17. The inverted mouse apparatus according to claim 15, wherein said circuit switch can be a push-on switch set on said first circuit board.

18. The inverted mouse apparatus according to claim 11, wherein said second sliding surface of said main surface structure and said second adsorptive element are set on a vertical-moving plate within said housing, and a third spring device and a third circuit board are disposed thereunder for supporting so that said third spring device is utilized to control said circuit switch.

19. The inverted mouse apparatus according to claim 18, wherein said circuit switch is made of said third spring device and said third circuit board.

20. The inverted mouse apparatus according to claim 13, wherein said second sliding surface of said main surface structure and said second adsorptive element are fixed within said housing; said movable plate is set between said housing and said second sliding surface of said main surface structure; an aperture of said housing is smaller than said movable plate, and said attaching element of said movable plate is exposed over said aperture so that said movable plate can be moved in horizontal and vertical direction and push down via said attaching element.

21. The inverted mouse apparatus according to claim 15, wherein said second sliding surface of said main surface structure and said second adsorptive element are fixed within said housing; said movable plate is set between said housing and said second sliding surface of said main surface structure; an aperture of said housing is smaller than said movable plate, and said attaching element of said movable plate is exposed over said aperture so that said movable plate can be moved in horizontal and vertical direction and push down via said attaching element.

22. The inverted mouse apparatus according to claim 18, wherein said second sliding surface of said main surface structure and said second adsorptive element are fixed within said housing; said movable plate is set between said housing and said second sliding surface of said main surface structure; an aperture of said housing is smaller than said movable plate, and said attaching element of said movable plate is exposed over said aperture so that said movable plate can be moved in horizontal and vertical direction and push down via said attaching element.

23. The inverted mouse apparatus according to claim 1, further comprising a round aperture set in the central position of said second sliding surface of said main surface structure.

24. The inverted mouse apparatus according to claim 23, wherein a rolling ball is set within said main surface structure, and a elastically-supporting and positioning structure is set under said rolling ball to support said rolling ball and make said rolling ball expose its small portion over said round aperture of said main surface structure.

25. The inverted mouse apparatus according to claim 24, wherein said elastically-supporting and positioning structure comprises a plurality of supporting spring devices.

26. The inverted mouse apparatus according to claim 24, wherein said rolling ball is made of a light-weight material to reduce the overall weight.

27. The inverted mouse apparatus according to claim 24, wherein said displacement-detecting device set on a forth circuit board is a rolling-ball displacement detector, and said rolling ball and said elastically-supporting and positioning structure are a portion of said rolling-ball displacement detector.

28. The inverted mouse apparatus according to claim 27, wherein said elastically-supporting and positioning structure of said rolling ball displacement detector further comprises a horizontally-mounted spring device disposed on said fourth circuit board; when said horizontally-mounted spring device is pressed by said rolling ball, said circuit switch can be activated to start the power-saving function and the cursor-positioning function of said movable plate.

29. The inverted mouse apparatus according to claim 28, wherein said circuit switch is made of said horizontally-mounted spring device and said fourth circuit board with a plurality of properly designed contact points set thereon.

30. The inverted mouse apparatus according to claim 28, wherein said circuit switch is a push-on switch set on said fourth circuit board.

31. The inverted mouse apparatus according to claim 24, wherein said second sliding surface of said main surface structure and said second adsorptive element are fixed within said housing; said movable plate is set between said housing and said second sliding surface of said main surface structure; an aperture of said housing is smaller than said movable plate, and said attaching element of said movable plate is exposed over said aperture so that said movable plate can be moved in horizontal and vertical direction and push down via said attaching element.

32. The inverted mouse apparatus according to claim 1, wherein said housing comprises a plurality of keys to assist the operation of said inverted mouse apparatus.

33. The inverted mouse apparatus according to claim 32, wherein said keys of said housing comprise a left-key, a right-key and a wheel-key; said left-key and said right-key are symmetrically set on the left-top side and the right-top side of said second sliding surface of said main surface structure; said wheel-key is set on the top side of said second sliding surface of said main surface structure and between said left-key and said right-key, so that said inverted mouse apparatus can be conveniently utilized for left-hand operation or right-hand operation.
